(19) United States
(12) Patent Application Publication
(10) Pub. No.: US 2023/0139465 A1
(43) Pub. Date: May 4, 2023

(54) ELECTRONIC SERVICE FILTER OPTIMIZATION

(71) Applicant: PAYPAL, INC., San Jose, CA (US)

(72) Inventors: Lokesh Nyati, Pune (IN); Manisha Reddy Gade, Warangal (IN)

(73) Assignee: PAYPAL, INC.

(21) Appl. No.: 17/516,491

(22) Filed: Nov. 1, 2021

(51) Int. Cl. G06Q 20/40; G06Q 20/38

(52) U.S. Cl. CPC G06Q 20/4016; G06Q 20/405; G06Q 20/389

(57) ABSTRACT

Systems and methods for optimizing filters for processing electronic services between end users are disclosed. In an embodiment, a computer system accesses scores corresponding to historic user actions. A first cutoff value and second cutoff value are determined for branches of a tree. A precision score for branches of the tree is calculated based on a number of historic user actions having chargebacks in relation to a number of historic user actions captured by the cutoff values of the branch. The computer system identifies a branch having a greatest precision score. The computer system determines that a threshold, defined by the first cutoff value and the second cutoff value for the identified branch, when used in a processing rule for a user account, changes a performance metric by a threshold amount. The computer system generates a recommendation for the user account to adjust a filter for the processing rule to use the threshold.

### TECHNICAL FIELD

The present disclosure generally relates to computer security and more particularly to optimizing filters for processing electronic services between end users according to various embodiments.

### BACKGROUND

Machine learning and artificial intelligence techniques can be used to improve various aspects of decision making. Machine learning techniques often involve using available data to construct a model that can produce an output (e.g., a decision, recommendation, prediction, etc.) based on particular input data. Training data (e.g., known/labeled data and/or previously classified data) may be used such that the resulting trained model is capable of rendering a decision on unknown data. Electronic service providers may use machine learning and artificial intelligence to evaluate requests for electronic services such as electronic interactions with users. Using various input data, machine learning models may output scores associated with a request for electronic service, where each score may quantify the request for electronic service, such as, for example, indicate a risk that the request should not be processed or otherwise canceled. Some user accounts may activate processing rules that filter electronic interactions and electronic transactions with other end users based on these scores. The present disclosure provides systems and methods for optimizing such filters to improve performance metrics such as computer resource utilization and processing efficiency.

### BRIEF DESCRIPTION OF THE FIGURES

FIG. 1 illustrates a flow diagram of a process for optimizing filters for processing electronic services between end users in accordance with one or more embodiments of the present disclosure.

FIG. 2 shows an example transaction history for a user account in accordance with one or more embodiments of the present disclosure.

FIG. 3 illustrates an example machine learning tree structure used for optimizing filters for processing electronic services between end users in accordance with one or more embodiments of the present disclosure.

FIG. 4 illustrates an example machine learning tree structure generated based on the transaction history of FIG. 2 and used for optimizing filters for processing electronic services between end users in accordance with one or more embodiments of the present disclosure.

FIG. 5 illustrates a user interface screen corresponding to processing rule filters for a user account in accordance with one or more embodiments of the present disclosure.

FIG. 6 illustrates a user interface screen 600 for editing an example processing rule filter 604 in accordance with one or more embodiments of the present disclosure.

FIG. 7 illustrates a block diagram of a networked system in accordance with one or more embodiments of the present disclosure is illustrated.

FIG. 8 illustrates a block diagram of a computer system implemented in accordance with one or more embodiments of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

User accounts may interact with other user accounts, as well as a service provider, in various systems. These accounts may in some instances may be used to perform electronic transactions or other electronic interactions with one another using electronic services provided by an electronic service provider. In some cases, electronic transactions may include transferring ownership of an asset (e.g., file permissions within a file system, digital ownership rights, an electronic payment transaction, or transfer of another electronic asset). When these transactions are recorded in a log and/or a database, a history of the transactions is developed. Certain account and transaction patterns may be indicative of certain types of actions performed by the user accounts, and in some cases, these actions may violate authorized use policies (AUPs) or otherwise be illegal and/or undesired by system owners. Identifying such patterns via human analysis may be difficult or impossible, however, especially as digital transactions and fraud become more and more prevalent.

Machine learning and artificial intelligence techniques can identify accounts and/or interactions that may be violating terms of service, committing a security violation, and/or performing illegal actions in a way that is not easily ascertainable (or impossible to ascertain) from human analysis. Such identification may be provided in the form of risk scores or other scores that indicate how likely the account and/or interaction is engaged in said actions and/or how confident that the scoring mechanism is in stating that the account and/or interaction is engaged in said actions.

These machine learning and artificial intelligence techniques can be used in combination with filter optimization to provide a technical advantage over previous techniques by reducing computational resources allocated to processing electronic services for undesired actions. For example, unnecessary computing power and storage space may be avoided if certain electronic transactions can be filtered out of processing queues by using optimized filters. For example, the filters may be optimized to reduce the number of chargeback transactions that are fully processed for a user account as a chargeback transaction may result in a cancelation of the transaction, which causes unnecessary use of computer processing resources. Further, the filters may be optimized to reduce the number of false-positive chargeback transactions that are rejected, which causes unnecessary computer processing operations to correct and causes additional processing delays.

As discussed herein, chargeback fraud may include circumstances in which a user account is used to make an online purchase with a user's credit card or other financial instrument (e.g., payment account balance or account currency), and then requests a chargeback from the issuing bank (or electronic transaction service provider) after receiving the purchased goods or services. Once approved, the chargeback cancels the transaction, and the user account receives a refund of the money spent while also keeping the purchased goods or services.

In one embodiment, a computer system is provided. The computer system may access scores (e.g., transaction risk scores) corresponding to historic transactions for a user account. The computer system may implement a machine learning tree-based algorithm in which, for each branch of a tree, the computer system determines a first cutoff value and a second cutoff value that captures a range of scores for the historic transactions. The computer system may calculate a precision score for branches of the tree based on a number of historic transactions having chargebacks in relation to a number of historic transactions captured by the cutoff values of the branch. The computer system may identify a branch of the tree that has a greatest precision score. The computer system may determine whether applying a threshold, defined by the first cutoff value and the second cutoff value for the identified branch, in a processing rule for the user account changes a performance metric for the user account by a threshold amount. For example, the performance metric may be a reduction in computing resources associated with processing chargeback transactions, a reduction in computing operations or processing delays associated with correcting rejections of false positive chargeback transactions, an increase in total transaction volume for the user account, and so forth. If the application of the threshold in the processing rule changes the performance metric for the user account by the threshold amount, the computer system may generate a recommendation for the user account to adjust a filter for the processing rule in the user account to the determined threshold.

Further details and additional embodiments are described below in reference to the accompanying figures.

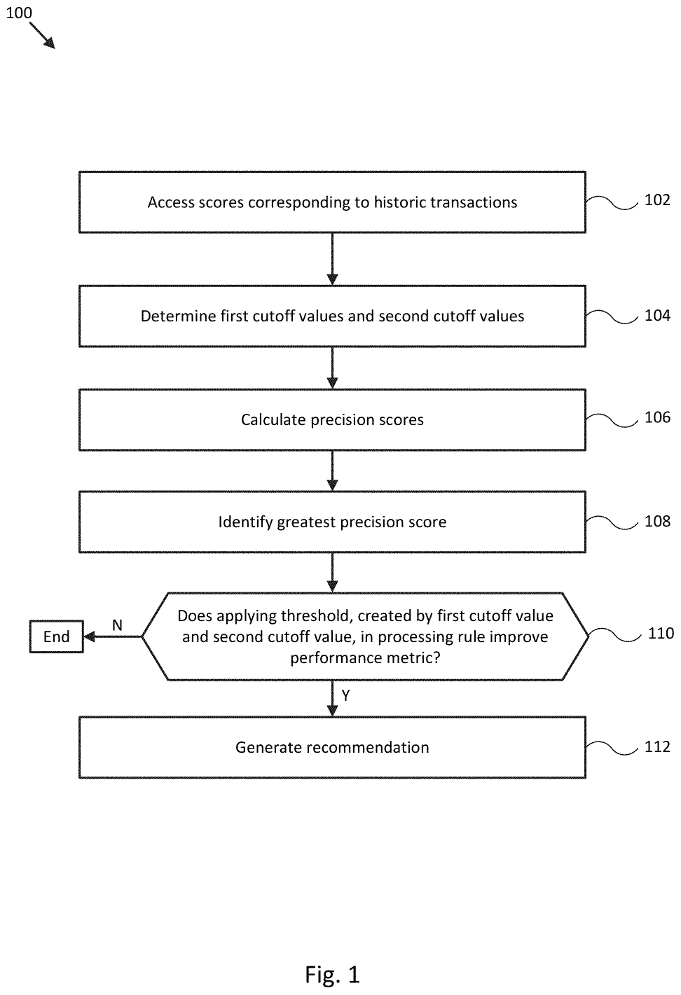

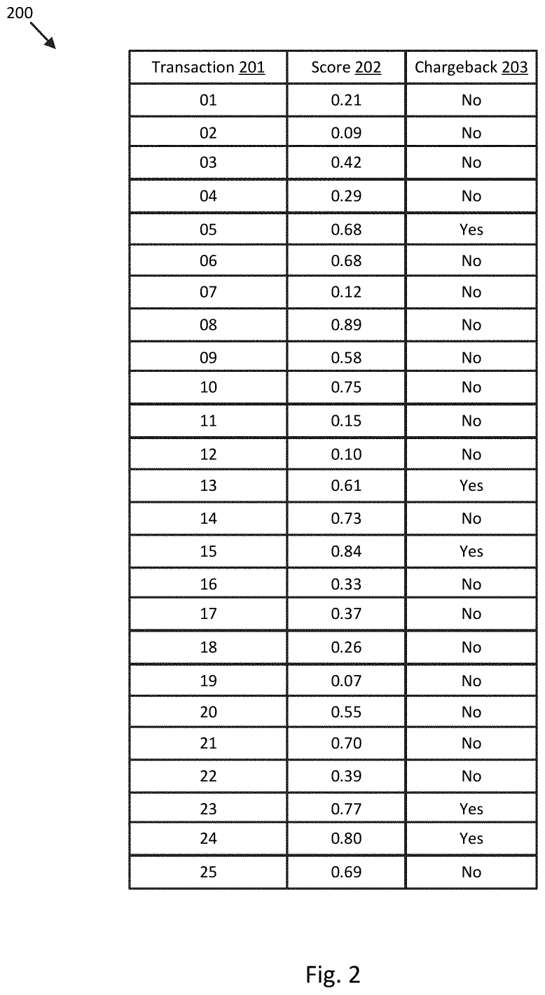

Referring now to FIG. 1, illustrated is a flow diagram of a process 100 for optimizing filters for processing electronic services between end users of a service provider in accordance with one or more embodiments of the present disclosure. The blocks of process 100 are described herein as occurring in serial, or linearly (e.g., one after another). However, multiple blocks of process 100 may occur in parallel. In addition, the blocks of process 100 need not be performed in the order shown and/or one or more of the blocks of process 100 need not be performed. For explanatory purposes, process 100 is primarily described herein with reference to FIGS. 2-5.

It will be appreciated that first, second, third, etc. are generally used as identifiers herein for explanatory purposes and are not necessarily intended to imply an ordering, sequence, or temporal aspect as can generally be appreciated from the context within which first, second, third, etc. are used.

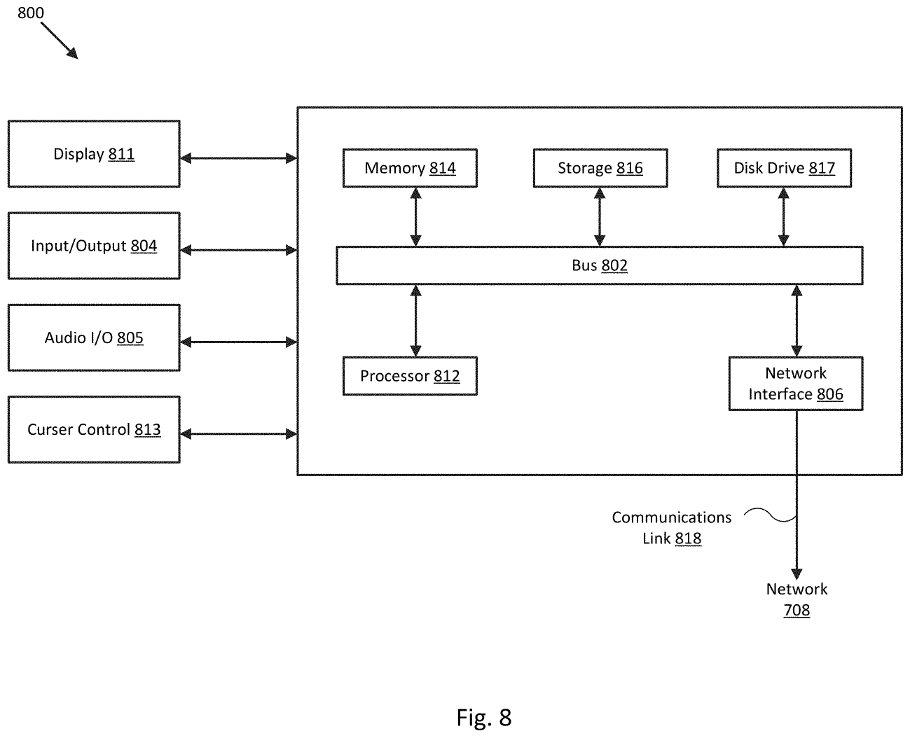

A computer system may perform the operations of process 100 in accordance with various embodiments. The computer system may include a non-transitory memory (e.g., a machine-readable medium) that stores instructions and one or more hardware processors configured to read/execute the instructions to cause the computer system to perform the operations of process 100. In various embodiments, the computer system may include one or more computer systems 800 of FIG. 8.

At block 102 of process 100, the computer system may access a transaction history 200 for a user account, as shown in and described with respect to FIG. 2. For example, the computer system may access a database using an account identifier associated with the user account to retrieve the transaction history 200. In some embodiments, the user account may be a merchant account registered with an electronic transaction service provider that manages the computer system.

In FIG. 2, twenty-five historic transactions 201 are shown in the transaction history 200 for simplicity of explanation, however, it will be appreciated that there may be more or less transactions in a transaction history. The transaction history 200 may include scores 202 that correspond to the historic transactions 201. One column of scores is shown in FIG. 2 for simplicity of explanation, however, it will be appreciated that there may be a plurality of different scores associated with each of the historic transactions 201. The transaction history 200 may further include chargeback information 203 corresponding to the historic transactions 201, which may indicate whether a historic transaction had a chargeback.

Examples of different scores may include transaction risk scores, IP address risk scores, mobile phone risk scores, emulator risk scores, fake email scores, geolocation risk scores, and other scores that quantify a riskiness or other quality of a transaction. A user account established with a service provider may adjust processing rules associated with the user account, where the processing rules operate by using the scores or other quantifying variables as input and outputting whether an electronic service, such as a transaction, or more generally an interaction between the user account and a counterparty end user, is processed. In other words, a processing rule may dictate whether an interaction is approved or rejected by filtering for scores. A user account may have one or more active processing rules, where each processing rule may have one or more filters comprised of threshold(s) that can be adjusted to define how the processing rule will operate for the user account.

As an illustration, one processing rule for the user account may relate to IP address risk scores. The processing rule may have a filter that causes transactions that have an IP address risk score, calculated based on an IP address corresponding to a counterparty end user in an interaction, that meets a threshold to be rejected (e.g., not processed for the user account) or approved (e.g., fully processed). To further illustrate, the processing rule for the IP address risk score may have a filter that rejects transactions that have an IP address risk score that is greater than a 0.80 threshold. The IP address risk scores may be determined for each transaction in real-time by a risk assessment system, for example. In such cases, the computer system of the present disclosure may execute process 100 to provide an output that informs the user account whether the currently active rule for IP address risk scores is too generous or too restrictive by recommending a threshold that would improve a performance metric for the user account, as further discussed at later blocks of process 100.

While reference is made herein to transactions, it will be appreciated that process 100 may generally be used to optimize filters for other processing rules for electronic service interactions between end users. For example, processing rule filters may be optimized to filter email or other messaging interactions as one example. Where processing rule filters are used for emails or messaging interactions, the processing rule may cause incoming messages to be rejected or approved based on a score associated with the sending user account, for example.

Further, while reference is made herein to scores, it will be appreciated that process 100 may be more generally used to optimize filter thresholds that relate to other types of processing rule variables, such as transaction amounts (e.g., currency amount for a transaction, a number of items in a transaction), geolocations, etc. For example, a processing rule filter may have a threshold that defines the currency amount over which a transaction will be rejected for presumably being fraudulent (e.g., a $1B transaction may be rejected as presumably being fraudulent if a processing rule has a threshold of $100 k over which transactions are rejected). As another example, a processing rule for geolocations may have a filter that has a threshold defined by a geofence in which counterparty end users must be located in order to interact with the user account that has set up the geolocation processing rule.

Referring back to FIG. 1, at block 104, the system may determine first cutoff values and second cutoff values to capture ranges for the scores 202 of the historic transactions 201. The first cutoff values and second cutoff values may be pairings of values that define thresholds that the computer system may consider for recommending a threshold for the user account if the threshold improves a performance metric for the user account, as further discussed at later blocks.

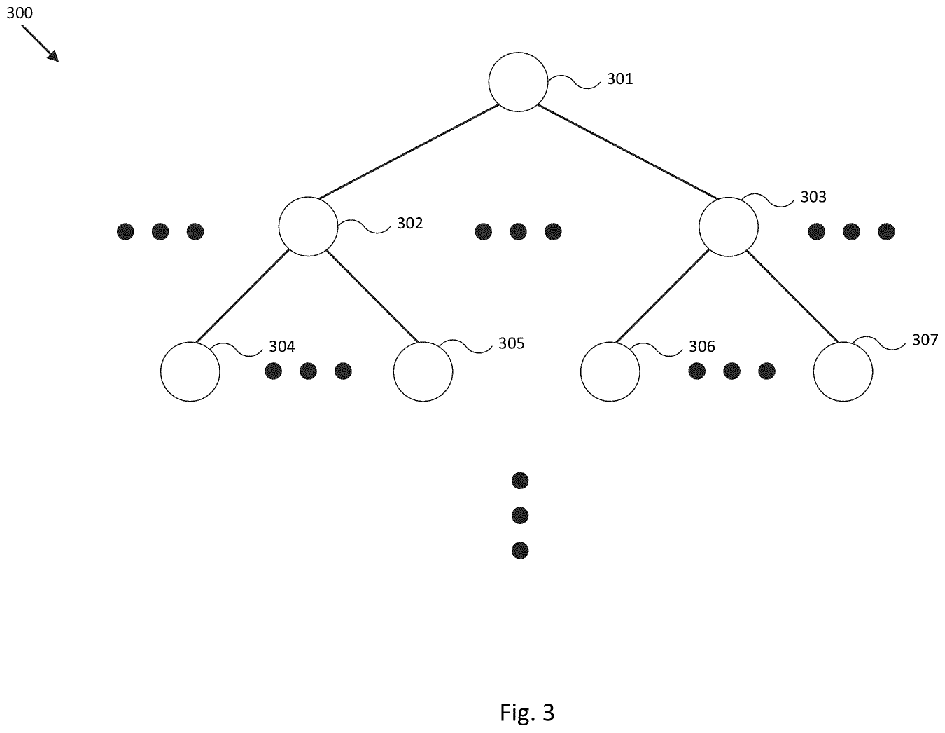

Referring to FIG. 3, illustrated is an example tree 300 having nodes 301-307. A root node 301 in the tree 300 may represent one of the first cutoff values that is determined for the historic transactions 201. In some embodiments, the first cutoff value for the root node 301 may be determined by sorting the historic transactions 201 by their scores 202 in an ascending or descending manner and selecting a score as the first cutoff value for which all transactions, that have chargebacks, have scores that exceed the first cutoff value (or meet the cutoff value or are below the cutoff value depending on implementation). For example, upon evaluation of the transaction history 200 of FIG. 2, a first cutoff value of 0.60 may be selected as all transactions, that have chargebacks, have scores that exceed the cutoff value of 0.60 (i.e., transactions 05, 13, 15, 23, and 24, which have chargebacks, have scores that exceed 0.60). Note that transactions that do not have chargebacks may still be captured in the set of transactions that have scores above 0.60 when 0.60 is selected as the first cutoff value in this example.

In another embodiment, a first cutoff value for the root node 301 may be determined by grouping the transactions that have chargebacks (e.g., transactions 05, 13, 15, 23, and 24 in transaction history 200), arranging them by score in descending or ascending order, and selecting a median score. For example, for the group of transactions 05, 13, 15, 23, and 24, which have chargebacks, the median score would be 0.77 belonging to transaction 23. Thus, the root node 301 may have a first cutoff value of 0.77 in this example. In other embodiments, an average score for the chargeback transactions may be determined and used for the first cutoff value of the root node 301.

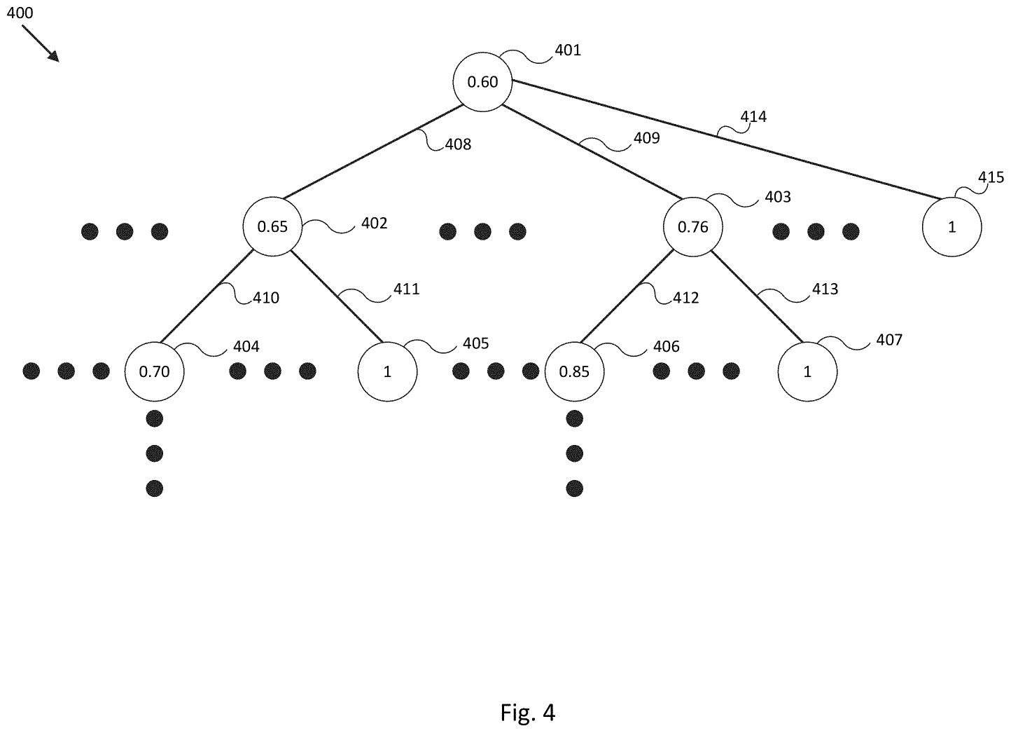

Turning to FIG. 4, an example in which the computer system may determine first cutoff values and second cutoff values to generate a tree 400 is shown. In the example shown in FIG. 4, the computer system has determined a first cutoff value at a root node 401 by sorting the historic transactions 201, such as by score (e.g., ascending or descending) or whether there was a chargeback (e.g., grouping), and selecting the score value of 0.60, which captures a set of transactions of the historic transactions 202, where each transaction in the captured set has a score that exceeds 0.60. The score value of 0.60 may particularly be selected to capture a subset of all transactions that have chargebacks. For example, transactions 05, 13, 15, 23, and 24 in transaction history 200 all have chargebacks and their scores exceed 0.60.

The computer system may determine second cutoff values for nodes 402, 403, and 415 at the level of nodes below the root node 401. For example, the second cutoff values may be the score values greater than the first cutoff value of the root node 401 up through a maximum value for the score, such as 1 in this example. The nodes corresponding to a first cutoff value and a second cutoff value may define a branch of the tree 400. For example, branch 408 may be defined by the first cutoff value of the root node 401 and a second cutoff value of node 402 (e.g., 0.65). Similarly, branches 409-414 may be defined by first cutoff values and second cutoff values of their respective connecting nodes. It is noted that a node in the tree 400 may act as a first cutoff value and/or second cutoff value and be part of a plurality of branches. For example, node 402 may represent a second cutoff value for branch 408 and a first cutoff value for branch 410.

The computer system may generate more branches of the tree 400 by iterating through each of the score values between the first cutoff value for branches on a level of the tree and a maximum cutoff value, which for explanatory purposes may be 1. For example, branches 408, 409, and 414 may be branches of a plurality of branches that have a first cutoff value at the root node 401 and a second cutoff value that iterates from 0.61 to 1. The ellipsis points in FIG. 4 indicate additional branches beyond the example branches shown in the tree 400. Branches 410-413 may have first cutoff values that are the second cutoff values from the branches at the level above (e.g., branches 408, 409, and 414). The computer system may continue to generate branches in the tree 400 until all ranges from the beginning of the first cutoff value for the root node 401 and ending with the maximum value for the scores, where no branches in the tree 400 have repeating first and second cutoff values. In other embodiments, to reduce computational complexity, the iterative process to determine the second cutoff values for branches can be done using greater denominations to reduce the number of branches that are generated at each level in the tree 400. For example, the iterative process for the tree 400 could have been done using denominations of 0.05 for the second cutoff values instead of 0.01, which would reduce the number of branches in the tree 400.

Referring back to FIG. 1, at block 106, the computer system may calculate precision scores for each branch generated for the tree 400. A precision score may be calculated as the ratio tp/(tp+fp), where tp is the number of true positives and fp is the number of false positives. A true positive may be a transaction that would be rejected because its score meets the threshold defined by the branch and is indeed a transaction that has a chargeback. A false positive may be a transaction that would be rejected because its score meets the threshold defined by the branch but is a transaction that does not have a chargeback.

For example, referring again to FIG. 4, for the branch 414, the threshold defined by nodes 401 and 415 would be [0.60, 1]. The number of true positives in the transaction history 200 that are captured by [0.60, 1] is 5 (i.e., transactions 05, 13, 15, 23, and 24). The number of false positives that are captured by [0.60, 1] is 6 (i.e., transactions 06, 08, 10, 14, 21, and 25). Thus, the precision score for branch 414 would be 0.4545 (e.g., 5/(5+6)).

As another example, for the branch 412, the threshold defined by nodes 403 and 406 would be [0.76, 0.85]. The number of true positives that are captured by [0.76, 0.85] is 3 (i.e., transactions 15, 23, and 24). The number of false positives that are captured by [0.76, 0.85] is 0. Thus, the precision score for branch 412 would be 1 (e.g., 3/(3+0)). Therefore, branch 412 has a greater precision score than branch 413.

In some embodiments, computational operations may be reduced by decreasing the number of branches for which a precision score is calculated. For example, the computer system may identify which branches have true positive numbers and limit the calculation of precisions scores to those branches that have at least one true positive number. Branches that do not have at least one true positive number may be bypassed. Further, since fewer precisions scores will be calculated, there will be fewer precisions scores to compare, which can further reduce computational operations at block 110 and increase the computational efficiency for the computer system in performing process 100.

In some embodiments, the computer system may also calculate a recall score for each of the branches. For example, the recall score may be calculated as the ratio tp/(tp+fn) where fn is the number of false negatives. In some embodiments, the recall score may be used to compare to a threshold to determine a condition is satisfied for the recall score before a branch is used for a recommendation. Thus, in some embodiments, at least one of the precision score or the recall score should be used in identifying branches that should be further analyzed as discussed below to determine whether the branch should be used in a recommendation. In some cases, an F-score may be used in a similar manner to recall score and/or precision score. Thus, while reference is primarily made to precision score in the present disclosure, it will be appreciated that some implementations may include the use of the recall score and/or F-score along with or instead of the precision score.

Returning to FIG. 1, at block 108, the computer system may identify a tree branch that has a greatest precision score. For example, the computer system may compare the precision scores that were calculated at block 108 to identify the tree branch that has the greatest precision score.

At block 110, the computer system may determine whether applying a threshold created by the first cutoff value and the second cutoff value for the identified branch from block 108 in a processing rule improves a performance metric. For example, an improvement to a performance metric may be a reduction in computational operations dedicated to processing chargeback transactions, such as by filtering out chargeback transactions and reducing computation operations that would be required to process the chargeback transaction.

Another improvement to a performance metric may be a reduction in a number of transactions that are rejected even though they are not chargeback transactions (e.g., reduction of false positive chargeback transactions). By reducing the number of transactions that are rejected even though they are not chargeback transactions, computational resources associated with correcting the improper rejections may be avoided.

Another improvement to a performance metric may be an increase in a total payment volume or revenue for the user account by application of the threshold, such as by having a more precise threshold that filters out chargeback transactions while allowing additional transactions without chargebacks to be approved. Various other performance metrics are contemplated and may be implemented according to certain embodiments.

In some embodiments, the computer system may determine whether applying the threshold in the processing rule improves the performance metric by simulating a transaction period for the user account with the processing rule adjusted to have the threshold in the simulation. For example, the computer system may retrieve the active processing rules for the user account and adjust the subject active processing rule for which the threshold was determined through process 100. The computer system may then run the simulation using the active processing rules and the adjusted processing rule having the new threshold applied. In some cases, the simulation may be based on a past window of transaction data for the user account, such as the past 30 or 60 days. The simulation may provide a result that indicates various performance metrics for the user account. If the desired performance metric results in an improvement, such as by a threshold amount, the computer system may proceed to block 112, otherwise the computer system may end process 100.

At block 112, the computer system may generate a recommendation to provide to the user account. For example, in response to the simulation result at block 110, the computer system may provide a notification to the user account suggesting that the subject processing rule should be changed to implement the determined threshold as it will improve the performance metric as concluded by running the simulation. In some embodiments, the recommendation may be provided in an analytics user interface for the user account in which the user account may adjust active filters for processing electronic services with other end users.

In some embodiments, the computer system may execute process 100 to tune (e.g., provide recommendations for) additional processing rules for the user account. In some cases, the computer system may operate on a schedule by which the computer system may execute process 100 for one or more of the active processing rules for the user account to see if there are any active processing rules that can be adjusted to improve performance metric(s) for the user account. For example, the computer system may be scheduled to evaluate the active processing rules and provide any recommendations at certain intervals (e.g., periodically, certain days of the month, certain days of the week, etc.).

In some embodiments, the user account may request to implement the recommendation for the active processing rule after being informed by the recommendation. In such cases, the computer system may adjust the active processing rule for the user account. In other embodiments, the computer system may automatically adjust the active processing rule in response to determining that the threshold applied to the active processing rule would result in an improved performance metric. In some cases, the computer system may first confirm that the user account has provided permission for the computer system to automatically make adjustments to active processing rules if the performance metric is shown to improve by a significant amount (e.g., exceeds a threshold amount).

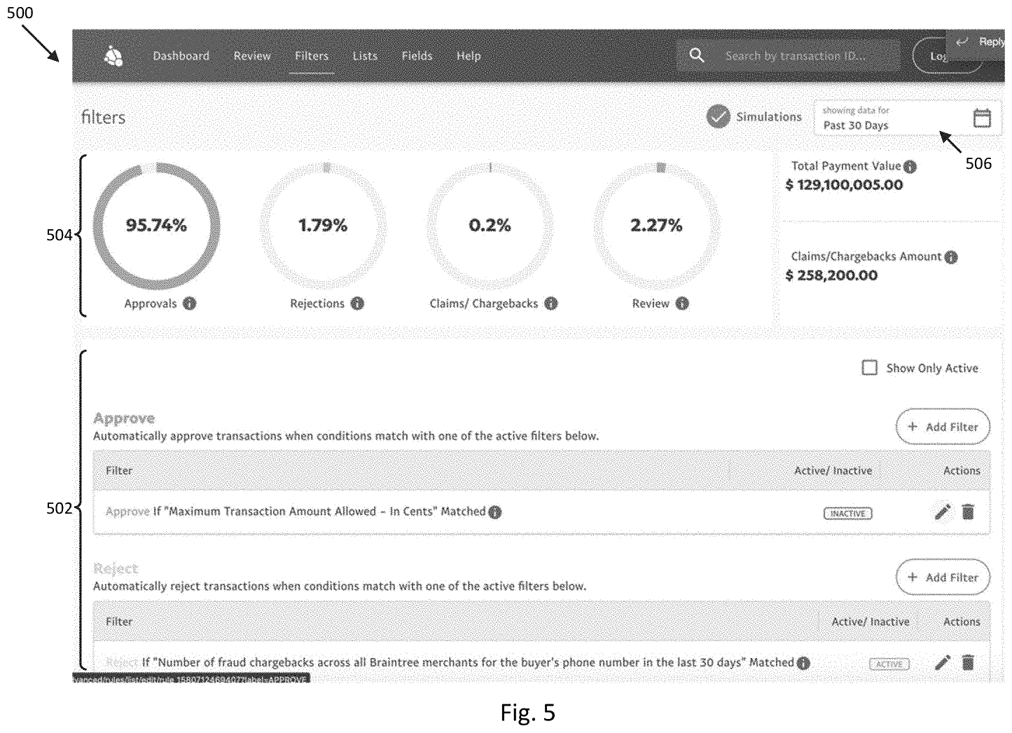

FIG. 5 illustrates a user interface screen 500 corresponding to processing rule filters for a user account in accordance with one or more embodiments of the present disclosure. The screen 500 may include a section 502 for a user to edit currently active processing rule filters for the user account. The screen 500 may further include a section 504 that indicates performance metrics for the user account for a period of time 506. For example, the performance metrics may include statistics for transaction approvals, transaction rejections, chargeback transactions, transactions requiring review, total payment value, and chargeback amount. Various other performance metrics as discussed herein may be implemented in the user interface screen 500 for the user account. In some embodiments, recommendations for adjustments to the processing rule filters may be provided in the user interface screen 500 for the processing rule filters.

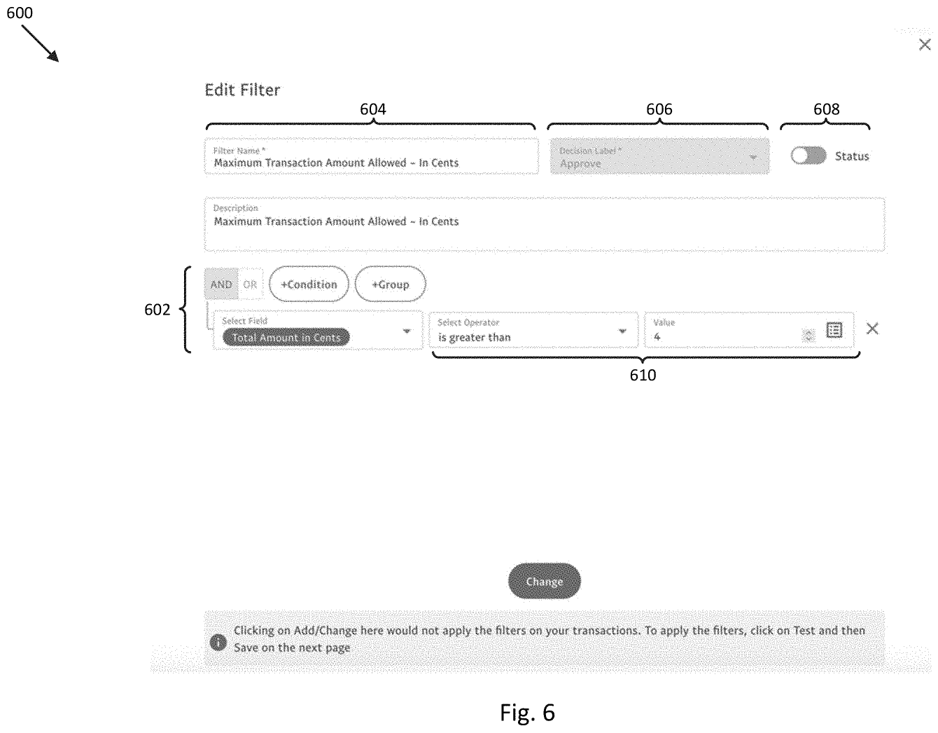

FIG. 6 illustrates a user interface screen 600 for editing an example processing rule filter 604 in accordance with one or more embodiments of the present disclosure. The screen 600 may include a condition 602 for the processing rule filter 604, where the condition 602 may have an adjustable threshold 610. If the condition is satisfied, the processing rule filter 604 may label a transaction according to the decision label 606. The processing rule filter 604 may be activated or deactivated using status switch 608. In some embodiments, the user interface screen 600 may provide recommendations for the threshold 610 as discussed herein.

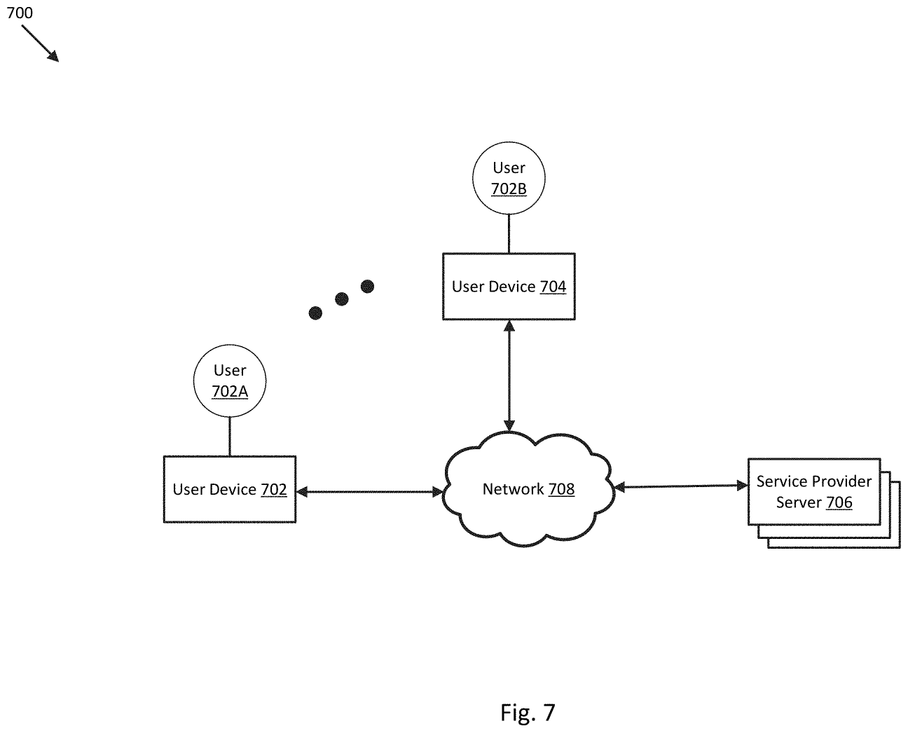

Referring now to FIG. 7, a block diagram of a networked system 700 configured to peer-to-peer interactions in accordance with one or more embodiments of the present disclosure is illustrated. System 700 includes a user device 702, a user device 704, and a peer-to-peer service provider server(s) 706. A user 702A is associated with user device 702, where user 702A can provide an input to service provider server 706 using user device 702. A user 702B is associated with user device 704, where user 702B can provide an input to service provider server 706 using user device 702B.

User device 702, user device 704, and service provider server 706 may each include one or more processors, memories, and other appropriate components for executing instructions such as program code and/or data stored on one or more computer-readable mediums to implement the various applications, data, and steps described herein. For example, such instructions may be stored in one or more computer-readable media such as memories or data storage devices internal and/or external to various components of system 700, and/or accessible over a network 708. Each of the memories may be non-transitory memory. Network 708 may be implemented as a single network or a combination of multiple networks. For example, in various embodiments, network 708 may include the Internet or one or more intranets, landline networks, and/or other appropriate types of networks.

User device 702 may be implemented using any appropriate hardware and software configured for wired and/or wireless communication over network 708. For example, in some embodiments, user device 702 may be implemented as a personal computer (PC), a mobile phone, personal digital assistant (PDA), laptop computer, and/or other types of computing devices capable of transmitting and/or receiving data, such as an iPhone™, Watch™, or iPad™ from Apple™.

User device 702 may include one or more browser applications which may be used, for example, to provide a convenient interface to facilitate responding to recipient account detail requests over network 708. For example, in one embodiment, the browser application may be implemented as a web browser configured to view information available over the internet and respond to requests sent by service provider server 706. User device 702 may also include one or more toolbar applications which may be used, for example, to provide client-side processing for performing desired tasks in response to operations selected by user 702A. In one embodiment, the toolbar application may display a user interface in connection with the browser application.

User device 702 may further include other applications as may be desired in particular embodiments to provide desired features to user device 702. For example, the other applications may include an application to interface between service provider server 706 and the network 708, security applications for implementing client-side security features, programming client applications for interfacing with appropriate application programming interfaces (APIs) over network 708, or other types of applications. In some cases, the APIs may correspond to service provider server 706. The applications may also include email, texting, voice, and instant messaging applications that allow user 702A to send and receive emails, calls, and texts through network 708, as well as applications that enable the user to communicate to service provider server 706 as discussed above. User device 702 includes one or more device identifiers which may be implemented, for example, as operating system registry entries, cookies associated with the browser application, identifiers associated with hardware of user device 702, or other appropriate identifiers, such as those used for user, payment, device, location, and or time authentication. In some embodiments, a device identifier may be used by service provider server 706 to associate user 702A with a particular account maintained by the service provider server 706. A communications application with associated interfaces facilitates communication between user device 702 and other components within system 700. User device 704 may be similar to user device 702.

Service provider server 706 may be maintained, for example, by an online service provider which may provide electronic transaction services. In this regard, service provider server 706 includes one or more applications which may be configured to interact with user device 702 and user device 704 over network 708 to facilitate the peer-to-peer transaction services. Service provider server 706 may maintain a plurality of user accounts (e.g., stored in a user account database accessible by service provider server 706), each of which may include account information associated with individual users. Service provider server 706 may communicate over network 708 with a payment network and/or other network servers capable a transferring funds between financial institutions and other third-party providers to complete transaction requests and process transactions, as well as run simulations as discussed herein.

FIG. 8 illustrates a block diagram of a computer system 800 suitable for implementing one or more embodiments of the present disclosure. It should be appreciated that each of the devices utilized by users, entities, and service providers discussed herein (e.g., the computer system) may be implemented as computer system 800 in a manner as follows.

Computer system 800 includes a bus 802 or other communication mechanism for communicating information data, signals, and information between various components of computer system 800. Components include an input/output (I/O) component 804 that processes a user action, such as selecting keys from a keypad/keyboard, selecting one or more buttons or links, etc., and sends a corresponding signal to bus 802. I/O component 804 may also include an output component, such as a display 811 and a cursor control 813 (such as a keyboard, keypad, mouse, etc.). I/O component 804 may further include NFC communication capabilities. An optional audio I/O component 805 may also be included to allow a user to use voice for inputting information by converting audio signals. Audio I/O component 805 may allow the user to hear audio. A transceiver or network interface 806 transmits and receives signals between computer system 800 and other devices, such as another user device, an entity server, and/or a provider server via network 708. In one embodiment, the transmission is wireless, although other transmission mediums and methods may also be suitable. Processor 812, which may be one or more hardware processors, can be a micro-controller, digital signal processor (DSP), or other processing component, processes these various signals, such as for display on computer system 800 or transmission to other devices via a communication link 818. Processor 812 may also control transmission of information, such as cookies or IP addresses, to other devices.

Components of computer system 800 also include a system memory component 814 (e.g., RAM), a static storage component 816 (e.g., ROM), and/or a disk drive 817. Computer system 800 performs specific operations by processor 812 and other components by executing one or more sequences of instructions contained in system memory component 814. Logic may be encoded in a computer-readable medium, which may refer to any medium that participates in providing instructions to processor 812 for execution. Such a medium may take many forms, including but not limited to, non-volatile media, volatile media, and transmission media. In various implementations, non-volatile media includes optical or magnetic disks, volatile media includes dynamic memory, such as system memory component 814, and transmission media includes coaxial cables, copper wire, and fiber optics, including wires that comprise bus 802. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 800. In various other embodiments of the present disclosure, a plurality of computer systems 800 coupled by communication link 818 to the network 708 (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure.

What is claimed is:

1. A computer system comprising:
a non-transitory memory storing instructions; and
one or more hardware processors configured to read the instructions and cause the computer system to perform operations comprising:
accessing scores corresponding to historic transactions for a merchant account;
for each of a plurality of branches in a machine learning algorithm tree, determining a first cutoff value and a second cutoff value that capture a range of scores for the historic transactions;
calculating a precision score for each of the plurality of branches based on a number of historic transactions having chargebacks captured in the range in relation to a number of historic transactions captured in the range;
identifying a branch that has a greatest precision score from the precision scores for each of the plurality of branches;
determining that applying a threshold defined by the first cutoff value and the second cutoff value for the identified branch in a transaction processing rule for the merchant account reduces computing operations associated with processing chargeback transactions; and
generating a recommendation to apply the threshold to provide to the merchant account.

2. The computer system of claim 1, wherein the operations are performed at a periodic interval.

3. The computer system of claim 1, wherein for a first branch in the machine learning algorithm tree, the first cutoff value is determined by sorting the historic transactions by score and selecting a median score.

4. The computer system of claim 1, wherein for a first branch in the machine learning algorithm tree, the first cutoff value is determined by sorting the historic transactions by score and selecting a score where all transactions having chargebacks are captured either above or below the score.

5. The computer system of claim 1, wherein the operations further comprise:
simulating a transaction period using the transaction processing rule with the threshold applied.

6. The computer system of claim 5, wherein the operations further comprise:
determining that applying the threshold increases a total transaction volume for the merchant account.

7. The computer system of claim 1, wherein the operations further comprise:
receiving a request to implement the recommendation from the merchant account; and
adjusting the transaction processing rule for the merchant account.

8. The computer system of claim 1, wherein the transaction processing rule is one of a plurality of transaction processing rules for the merchant account.

9. The computer system of claim 1, wherein the transaction processing rule comprises rejecting transactions that have an IP address risk score that does not meet the threshold.

10. A method comprising:
determining cutoff values for a plurality of branches in a tree, wherein the cutoff values for each branch in the tree captures a score of at least one chargeback transaction from historic transactions for a merchant account;
calculating a precision score for each branch based on a number of historic transactions having chargebacks in relation to a number of historic transactions captured by the cutoff values of the branch;
identifying a branch that has a greatest precision score from scores for each of the plurality of branches;
determining, based on a simulated period, that the cutoff values for the identified branch when used as a threshold in a transaction processing rule for the merchant account reduces at least one computational operation associated with processing transactions that have chargebacks in the simulated period;
generating a recommendation to apply the threshold to the transaction processing rule; and
providing the recommendation to the merchant account.

11. The method of claim 10, further comprising:
simulating a period using the threshold applied in the transaction processing rule; and
determining that the at least one computational operation is reduced by a threshold reduction.

12. The method of claim 10, wherein a cutoff value for a root node in the tree is determined by grouping the historic transactions into chargeback transactions and non-chargeback transactions and selecting the cutoff value that captures all of the scores of the chargeback transactions.

13. The method of claim 10, wherein the transaction processing rule is one of a plurality of transaction processing rules for the merchant account, and wherein the method further comprises:
simulating a period using the threshold applied in the transaction processing rule while other transactions processing rules of the plurality of transaction processing rules have currently active thresholds for the merchant account applied.

14. The method of claim 10, further comprising determining that the at least one computational operation is reduced by a threshold reduction.

15. The method of claim 10, wherein the recommendation is provided in a merchant account analytics user interface.

16. The method of claim 10, wherein the scores comprise IP address risk scores.

17. A non-transitory machine-readable medium having instructions stored thereon, wherein the instructions are executable to cause a machine of a system to perform operations comprising:
accessing scores corresponding to historic transactions for a merchant account;
determining cutoff values for a plurality of branches in a tree;
calculating a precision score, for each of the plurality of branches, based on a number of historic transactions having chargebacks in relation to a number of historic transactions captured by the cutoff values;
comparing the precision scores of the plurality of branches;
identifying a branch that has a greatest precision score from the precision scores;
determining that using the cutoff values of the identified branch as a threshold in a transaction processing rule for the merchant account reduces computational operations associated with processing chargeback transactions for the merchant account; and
generating a recommendation to apply the threshold to provide to the merchant account.

18. The non-transitory machine-readable medium of claim 17, wherein the operations are performed at a scheduled interval.

19. The non-transitory machine-readable medium of claim 17, wherein the recommendation is provided in an analytics user interface for the merchant account.

20. The non-transitory machine-readable medium of claim 17, wherein the threshold captures all of the historic transactions having chargebacks and none of the historic transactions that do not have chargebacks.
